(19) United States
(12) Patent Application Publication
(10) Pub. No.: US 2004/0117073 A1
(43) Pub. Date: Jun. 17, 2004

(54) Method and apparatus for controlling a locomotive

(75) Inventor: Folkert Horst, Pierrefonds (CA)

Correspondence Address: DARBY & DARBY P.C., P. O. BOX 5257, NEW YORK, NY, 10150-5257, US

(73) Assignee: CANAC INC., St-Laurent (CA)

(21) Appl. No.: 10/728,316

(22) Filed: Dec. 2, 2003

Related U.S. Application Data
(60) Provisional application No. 60/430,091, filed on Dec. 2, 2002.

(51) Int. Cl. G06F 7/00

(52) U.S. Cl. 701/2; 701/19

(57) ABSTRACT

A method and system for remotely controlling a locomotive. The system includes a remote control unit, a repeater module and a trail controller positioned onboard the locomotive. The components of the system are assigned time intervals during which they are permitted to transmit a signal over a communication channel. A first time interval is assigned to the remote control unit for transmission of remote control signals over a first communication channel. A second time interval is assigned to the repeater module for transmission of remote control signals over the first communication channel, the first time interval and the second time interval being non-overlapping. A third time interval is assigned to the trail controller mounted onboard the locomotive for transmission of trail controller signals over a second communication channel distinct from the first communication channel. A fourth time interval is assigned to the repeater module for transmission of trail controller signals over the second communication channel, the third time interval and the fourth time interval being non-overlapping.

### CROSS REFERENCE TO RELATED APPLICATIONS

This application claims the benefit of U.S. provisional application serial No. 60/430,091 filed Dec. 2, 2002. The contents of the above ducment are incorporated herein by reference.

### FIELD OF THE INVENTION

The present invention relates to components of a system for remotely controlling a locomotive. It is particularly applicable to the allocation of bandwidth to the different components in the control system.

### BACKGROUND

Electronic controllers are commonly used in the industry to regulate the operation of a wide variety of systems. In a specific example, electronic controllers are used to control remotely vehicles such as locomotives in order to perform functions including braking, traction control and acceleration without the necessity of a human operator on board the locomotive. Radio frequency transmitter-receiver pairs are of particular interest for remotely controlling such vehicles. In a typical locomotive control system, the operator communicates with a trail controller onboard the locomotive using a remote control device. The remote control device includes an electronic circuit placed in a suitable casing that provides mechanical protection to the electronic components.

In use, the operator of the locomotive enters requests into the remote control device via an input means such as switches, a keyboard, touch screen or any other suitable input means. Typical requests may include braking, accelerating and any other function that a locomotive may be required to perform. The remote control device encodes the request into a form suitable for transmission over a given communication link. The complete request is then modulated at a pre-determined radio frequency and transmitted as a RF signal. Frequencies other than RF have also been used for this purpose. The trail controller onboard the locomotive receives and demodulates the RF signal originating from the remote control unit. Optionally, the trail controller onboard the locomotive may also transmit information back to the remote control unit. In such a case, the trail controller encodes the request into a form suitable for transmission over a given communication link. The complete request is then modulated at a pre-determined radio frequency and transmitted as a RF signal. The remote control unit is equipped with a receiver to receive and demodulate the RF signal originating from the trail controller.

Frequently, a repeater unit receives the RF signal originating from either one of the remote control unit or the trail controller. Typical repeater units are ground-based units whose function is to extend the radio frequency (RF) range of the transmitter of the remote control unit or the trail controller by amplifying the signal and filtering noise components. Repeater units typically comprise an RF antenna, an RF receiver, a decoder/encoder, an RF re-transmitter and any other equipment such as filters, duplexors and others required to receive a signal, process it and retransmit it. Commonly, the repeater unit re-transmits the signal at a frequency different from the frequency of the signal, such that the two signals can be resolved if they are received simultaneously by a receiver unit. For example, if the remote control unit transmits a signal at a frequency F1, the repeater will retransmit the signal at a frequency F2 such that the trail controller onboard the locomotive can resolve the two signals.

Class I railroads in the United States have begun a rapid deployment of remote control technology. Due to the very limited availability of expensive, licensed frequency spectrum, many remote control devices must operate on a same radio frequency channel or on overlapping radio frequency channels often resulting in interference between the various signals. Signals transmitted in overlapping frequency channels cannot be resolved into their respective signals by a receiver in the trail controller (or the remote control unit in the case of a signal transmitted from the trail controller). The interference of the signals typically causes requests to be lost. Many methods have been proposed for reducing the effects of interference and controlling access to the communication channels.

Two commonly used categories of channel access methods are contention protocols and time-division multiple-access (TDMA) protocols.

Contention protocols allow each station to transmit (or attempt to transmit) at will, with the resulting occurrence of message collisions. In such protocols, a communication is transmitted repetitively at a given repetition rate. Certain ones of the transmissions collide with others and do not successfully arrive to destination while others arrive successfully. In one approach to resolve this issue, each communication unit, in such systems, is assigned a unique repetition rate. The unique repetition rate reduces the likelihood of messages interfering with one another. Many methods of assigning transmission rates are well-known in the art to which this invention pertains. For examples of methods for assigning repetition rates, the reader may refer to U.S. Pat. No. 4,245,347 by Hutton et al., and U.S. Pat. No. 6,456,674 entitled “Method and apparatus for automatic repetition rate assignment in a remote control system” by Horst et al. whose contents are hereby incorporated by reference.

Conversely, TDMA protocols require that a fixed period of time be divided into time intervals reserved specifically for transmissions from individual stations (e.g. remote control unit (OCU) or locomotive control unit (LCU)). In theory, no conflicts or message collisions will occur as a result of other stations operating within the protocol scheme. Interference and signal strength issues still exist and result in missed messages.

A deficiency with the existing TDMA protocols is that they provide no suitable scheme for allocating time intervals between a remote control unit, a trail controller module and a repeater unit.

Thus, there exists a need in the industry to provide a scheme for allocating time intervals between a remote control unit, a trail controller module and a repeater unit that alleviates at least in part the deficiencies of the existing systems.

### SUMMARY

In accordance with a broad aspect, the invention provides a method for assigning time intervals to communication components in a locomotive remote control system. The assigned time intervals indicate time segments during which a communication component is permitted to transmit a signal over a communication channel. A first time interval is assigned to a remote control unit for transmission of remote control signals over a first communication channel. A second time interval is assigned to a repeater module for transmission of remote control signals over the first communication channel. The first time interval and the second time interval are non-overlapping. A third time interval is assigned to a trail controller mounted onboard the locomotive for transmission of trail controller signals over a second communication channel distinct from the first communication channel. A fourth time interval is assigned to the repeater module for transmission of trail controller signals over the second communication channel. The third time interval and the fourth time interval are non-overlapping.

In accordance with a specific implementation, either one or both of the first time interval and the second time interval can be overlapping at least in part with either one or both of the third time interval and the fourth time interval.

In a specific non-limiting example of implementation where there are multiple remote control units and multiple locomotives, respective time sub-intervals of the first time interval are assigned to each of the multiple remote control units. The time sub-intervals are non-overlapping with one another. Each remote control unit is adapted to transmit remote control signals over the first communication channel during its respective time sub-interval. Respective sub-intervals of the third time interval are assigned to each of the trail controllers mounted onboard respective locomotives. The time sub-intervals of the third time interval are non-overlapping with one another. Each trail controller is adapted for transmitting trail controller signals over the second communication channel during its respective time sub-interval.

In a specific non-limiting example of implementation where there are multiple repeater units, respective time sub-intervals of the second time interval are assigned to the multiple repeater modules. The time sub-intervals of the second time interval are non-overlapping. Each repeater module is adapted for transmitting remote control signals over the first communication channel during its respective time sub-interval.

In a specific implementation, the first, second, third and fourth time intervals are measured with respect to a reference clock. Any suitable reference clock may be used without detracting from the spirit of the invention. In a non-limiting example, the reference clock is derived on the basis of a GPS system.

In accordance with another broad aspect, the invention provides a system for remotely controlling a locomotive. The system includes a remote control unit, a repeater module and a trail controller positioned onboard the locomotive. The remote control unit is adapted for transmitting, during a first time interval, a remote control signal over a given communication channel. The repeater module is adapted for receiving and processing the remote control signal transmitted over the given communication channel by the remote control unit to generate an amplified version of the remote control signal. The repeater transmits the amplified version of the remote control signal over the given communication channel during a second time interval, the first time interval and the second time interval being non-overlapping. The trail controller positioned onboard the locomotive is adapted for receiving either one of the remote control signal and the amplified version of the remote control signal over the given communication channel.

In accordance with a specific implementation, the given communication channel is a first communication channel. The trail controller is adapted for transmitting, during a third time interval, a trail controller signal over a second communication channel distinct from the first communication channel. The repeater module is adapted for receiving and processing the trail controller signal transmitted over the second communication channel by the trail controller to generate an amplified version of the trail controller signal. The repeater module is adapted to transmit the amplified version of the trail controller signal over the second communication channel during a fourth time interval, the third time interval and the fourth time interval being non-overlapping. The remote control unit is adapted for receiving either one of the trail controller signal and the amplified version of the trail controller signal over the second communication channel.

In accordance with a specific implementation, either one or both of the first time interval and the second time interval can be overlapping at least in part with either one or both of the third time interval and the fourth time interval.

In accordance with a specific implementation, the system for remotely controlling a locomotive includes a plurality of remote control units adapted for transmitting remote control signals over a given communication channel. The remote control units are assigned respective time sub-intervals of the first time interval, the time sub-intervals being non-overlapping with one another. Each remote control unit is adapted to transmit remote control signals over the first communication channel during its respective time sub-interval.

In accordance with another specific implementation, the system for remotely controlling a locomotive includes a plurality of repeater modules. The repeater modules are assigned respective time sub-intervals of the second time interval, the time sub-intervals of the second time interval being non-overlapping with one another. Each repeater is adapted to transmit remote control signals over the first communication channel during its respective time sub-interval.

In accordance with another broad aspect, the invention provides a method for assigning time intervals to communication components in a locomotive remote control system. The time intervals indicate time segments during which a communication component is permitted to transmit a signal over a communication channel. A first time interval is assigned to a remote control unit for transmission of remote control signals over a first communication channel to a trail controller positioned onboard a locomotive. A second time interval is assigned to a repeater module for transmission of remote control signals over the first communication channel to the trail controller positioned onboard a locomotive, the first time interval and the second time interval being non-overlapping.

### BRIEF DESCRIPTION OF THE DRAWINGS

A detailed description of examples of implementation of the present invention is provided hereinbelow with reference to the following drawings, in which:

FIG. 1 shows a simplified functional block diagram of a radio communication system including a specific example of implementation of the present invention;

FIG. 2a shows a first communication channel divided into TDMA frames in accordance with a specific example of implementation of the present invention;

FIG. 2b shows a second communication channel divided into TDMA frames in accordance with a specific example of implementation of the present invention;

FIG. 3 shows a simplified functional block diagram of a radio communication system including a specific example of implementation of the present invention where multiple repeaters are involved;

FIG. 4a is a functional block diagram of the transmitter portion of a remote control unit in accordance with a specific non-limiting example of implementation;

FIG. 4b is a functional block diagram of the receiver portion of a remote control unit in accordance with a specific non-limiting example of implementation;

FIG. 5a is a functional block diagram of a repeater module showing the components for the first communication channel in accordance with a specific non-limiting example of implementation;

FIG. 5b is a functional block diagram of a repeater module showing the components for the second communication channel in accordance with a specific non-limiting example of implementation;

FIG. 6a is a functional block diagram of a trail controller showing the components for the first communication channel in accordance with a specific non-limiting example of implementation;

FIG. 6b is a functional block diagram of a trail controller showing the components for the second communication channel in accordance with a specific non-limiting example of implementation.

In the drawings, embodiments of the invention are illustrated by way of example. It is to be expressly understood that the description and drawings are only for purposes of illustration and as an aid to understanding, and are not intended to be a definition of the limits of the invention.

### DETAILED DESCRIPTION

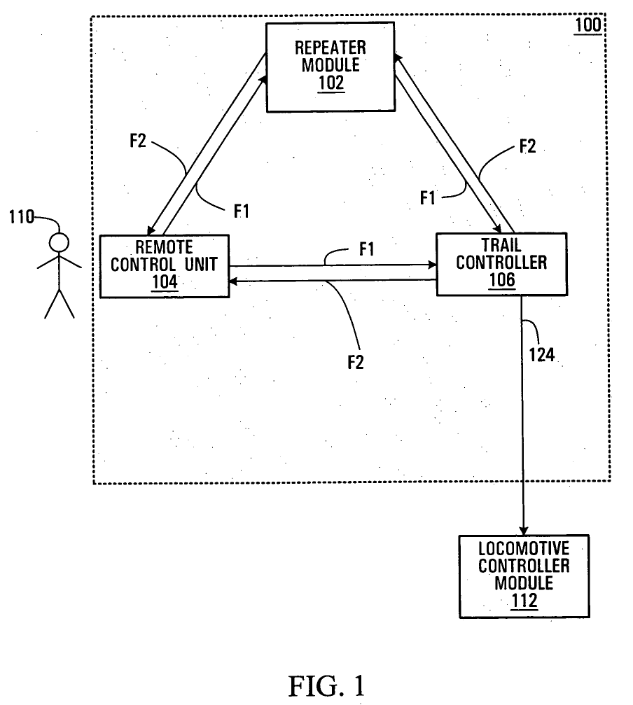

As shown in FIG. 1, the remote control system 100 includes a set of communication components namely a portable remote control unit 104, a repeater module 102 and a trail controller 106 mounted on board the locomotive. The trail controller 106 generates the proper control signals and interfaces those control signals with the main controller module 112 provided in the locomotive to regulate the operation of the engine, braking system and other devices.

The remote control unit 104 and repeater module 102 transmit signals to the trail controller 106 over a first communication channel using a TDMA based channel access method. The trail controller 106 is adapted for receiving remote control signals originating from either one of the remote control unit 104 and the repeater module 102 over the first communication channel. In accordance with a specific implementation, the repeater module 102 and the trail controller 106 transmit signals to the remote control unit 104 over a second communication channel using a TDMA based channel access method. The remote control unit 104 is adapted for receiving trail controller signals originating from either one of the trail controller 106 and the repeater module 102 over the second communication channel. The first communication channel is characterized by a first frequency band centered on frequency F1 and the second communication channel is characterized by a second frequency band centered on frequency F2. In a specific implementation, frequencies F1 and F2 are in the radio frequency range.

The duration of a TDMA frame may vary from one implementation to another and is generally directed by the desired responsiveness of the system 100. In addition, the duration of a TDMA frame over the first communication channel may differ from the duration of a TDMA frame over the second communication channel. For example, suppose that it is desirable that a command issued by the remote control unit 104 takes no more than 1 second to reach the trail controller 106. In order to satisfy this requirement, each remote control unit/repeater pair should be given a time interval at least once per second. The TDMA frame is thus considered to be 1 second in duration, and will be the unit of time that is partitioned into time intervals.

Each of the components in the remote control system is provided with a reference clock signal such as to allow the components to measure TDMA frames and time intervals from a common reference point. Many suitable methods for providing clock synchronization exist. In a non-limiting implementation, the reference clock is derived in the basis of a GPS system. The use of a GPS system for providing a reference clock signal is well-known in the art and as such will not be described further here.

For a given communication channel, each TDMA frame is divided into time intervals. The time intervals are assigned to respective components of the remote control system 100. The time intervals indicate time segments of the frame during which a communication component is permitted to transmit a signal over the communication channel.

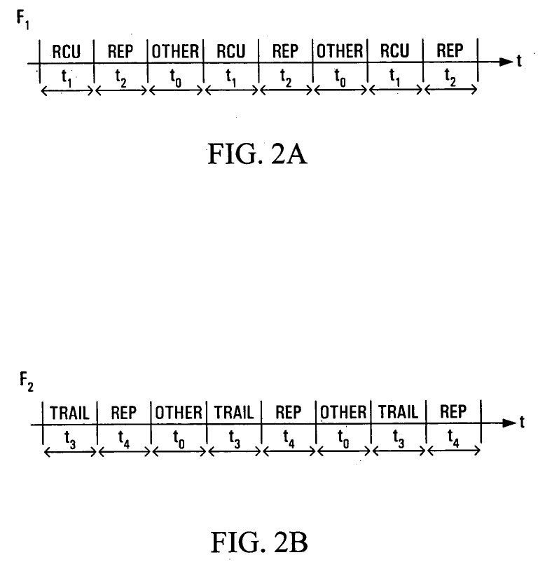

In a first specific implementation, for the first communication channel (F1), time intervals of the TDMA frame are assigned to the remote control unit 104 and the repeater module 102. The time intervals indicate time segments during which the remote control unit 104 and the repeater module 102 are permitted to transmit signals over the first communication channel. In a non-limiting example shown in FIG. 2a, a first time interval t₁ is assigned to remote control unit 104 for transmission of remote control signals over the first communication channel. A second time interval t₂ is assigned to repeater module 102 for transmission of remote control signals over the first communication channel, the first time interval and the second time interval being non-overlapping. The first time internal and the second time interval may be of the same duration or have different durations without detracting from the spirit of the invention.

For the second communication channel (F2), time intervals of the TDMA frame are assigned to the trail controller 106 and the repeater module 102. The time intervals indicate time segments during which the trail controller 106 and the repeater module 102 are permitted to transmit signals over the second communication channel (F2). In a non-limiting example, shown in FIG. 2b, a third time interval t₃ is assigned to trail controller 106 for transmission of trail controller signals over the second communication channel (F2). A fourth time interval t₄ is assigned to repeater module 102 for transmission of remote control signals over the second communication channel (F2). The third time interval and the fourth time interval are non-overlapping. The third time internal and the fourth time interval may be of the same duration of have different durations without detracting from the spirit of the invention.

Since the first communication channel (F1) and the second communication channel (F2) are distinct, either one or both of the first time interval and the second time interval can be overlapping at least in part with either one or both of the third time interval and the fourth time interval.

In addition, in accordance with a non-limiting implementation, a TDMA frame may be further divided to include a time interval to during which overhead functions may be performed. Such overhead functions may include, without being limited to, providing a reference clock signal and time interval allocation, amongst others.

In addition, it will be appreciated that during a TDMA frame over the first communication channel, the remote control unit and the repeater module 102 may each transmit multiple times without detracting from the spirit of the invention. Similarly, during a TDMA frame over the second communication channel, the trail controller 106 and the repeater module 102 may each transmit multiple times without detracting from the spirit of the invention.

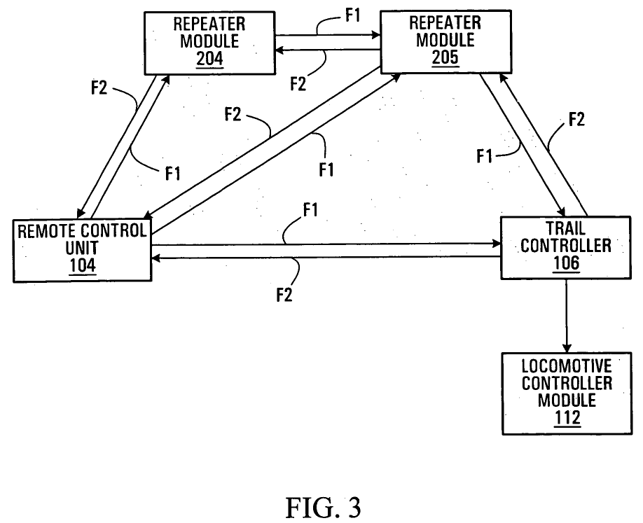

In a second specific implementation including multiple repeaters, for the first communication channel the second time interval is subdivided into multiple time sub-intervals. The time sub-intervals are non-overlapping with one another. The time sub-intervals are assigned to respective repeater modules. Each repeater module is adapted for transmitting remote control signals over the first communication channel during its respective time sub-interval. For the second communication channel, the fourth time interval is subdivided into multiple time sub-intervals. The time sub-intervals are non-overlapping with one another. The time sub-intervals are assigned to respective repeater modules. Each repeater module is adapted for transmitting trail controller signals over the second communication channel during its respective time sub-interval. FIG. 3 of the drawings shows a remote control system including two repeater units 204 and 205. In this case, the TDMA frame over the first communication link (F1) is divided between repeater 204, repeater 205 and the remote control unit 104. The TDMA frame over the second communication link (F1) is divided between repeater 204, repeater 205 and the trail controller 106.

In a third specific implementation, the remote control system includes multiple remote control units of the type of remote control unit 104 and multiple trail controllers of the type of trail controller 106. For the first communication channel, the first time interval is subdivided into multiple time sub-intervals. The time sub-intervals are non-overlapping with one another. The time sub-intervals are assigned to respective remote control units. Each remote control unit is adapted for transmitting remote control signals over the first communication channel during its respective time sub-interval. For the second communication channel, the third time interval is subdivided into multiple time sub-intervals. The time sub-intervals are non-overlapping with one another. The time sub-intervals are assigned to respective trail controllers. Each trail controller is adapted for transmitting trail controller signals over the second communication channel during its respective time sub-interval. In this case, the TDMA frame over the first communication link (F1) is divided between the multiple remote control units and the repeater module. The TDMA frame over the second communication link (F1) is divided between the repeater module and the multiple trail controllers.

As mentioned above, in accordance with a non-limiting implementation, a TDMA frame may be further divided to include a time interval during which overhead functions may be performed. Such overhead functions may include, without being limited to, providing a reference clock signal and time interval allocation, amongst others. For example, a TDMA frame to be used over the first communication channel would include:

1. a first time interval during which the remote control unit 104 could transmit;

2. a second time interval during which the repeater unit could transmit, the first and second time intervals being non-overlapping;

3. a third time interval during which signal directed to overhead functions may be transmitted, the first, second and third time intervals being non-overlapping. The third time interval is assigned to one or more communication components performing the overhead functions. For example, if a central processing entity is in charge of transmitting reference clock information and time interval allocation, then the central processing entity would be assigned the third time interval. When there are multiple components performing a multiple overhead functions, each component is assigned a non-overlapping sub-interval of the third time interval

A corresponding TDMA frame to be used over the second communication channel would include:

1. a first time interval during which the trail controller 106 could transmit;

2. a second time interval during which the repeater unit 102 could transmit, the first and second time intervals being non-overlapping;

3. a third time interval during which signal directed to overhead functions may be transmitted, the first, second and third time intervals being non-overlapping.

Allocation of Time Intervals

Any suitable method for allocating time intervals within a TDMA frame may be used. Non-overlapping time intervals are assigned to individual communication components so they may properly access the communication channels without interfering with other components.

In a first specific implementation, the assignment of time intervals is done statically. In this configuration, each component of the remote control system 100, namely each of the remote control unit 104, repeater unit 102 and trail controller 106, is manually configured with the time intervals during which they can transmit on a given communication channel. In an alternative implementation, instead of a manual interface, an infra-red interface may be used for communicating the time intervals to the components of the control system 100. In this alternative configuration, an operator programming entity storing the time interval allocation is provided. The operator programming entity includes an infra red interface adapted for communication with the infra-red interfaces of the components of the control system 100 for conveying the time intervals.

A central management system is used in order to ensure that not two time intervals on a same communication channel are overlapping. The central management system may be a simple list which is manually updated and which indicates the time intervals and their allocation or alternatively may be a computerized system.

In a second specific implementation, a dynamic assignment of time intervals is used. In this second configuration, a configuration server is used for dynamically allocating time intervals as new components are added and removed from the control system 100.

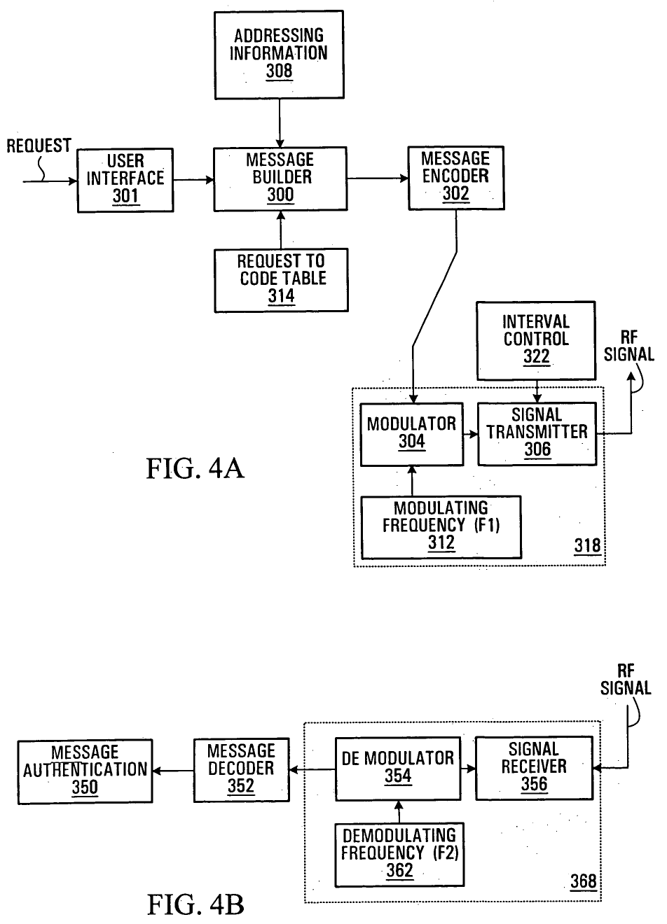

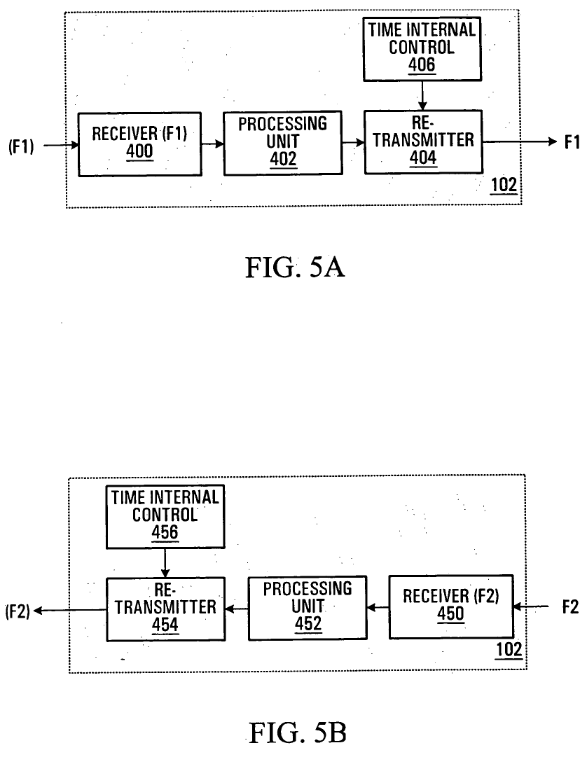

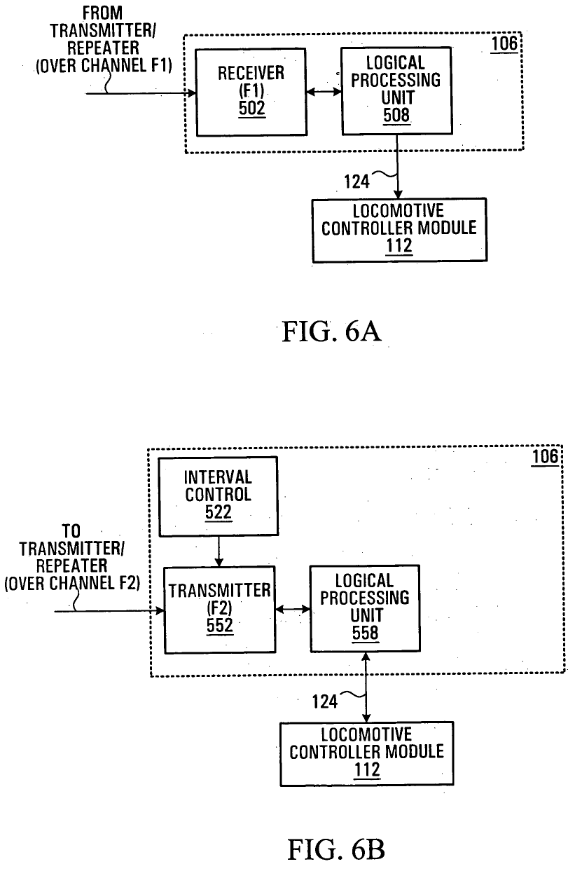

In a third specific implementation, the components of the control system 100 self-manage the time interval assignment. In this approach, no external source of time interval configuration management is required, e.g. manual configuration, configuration server. This may be effected for example by including in each transmission from the trail controller 106 a set of commands indicative of the time interval allocation of each of the remote control unit 104 and the repeater unit 102. Upon receipt of a transmission from the trail controller 106, the remote control unit 104 and the repeater unit 102 update their respective interval control modules 322 (shown in FIG. 4a), 406 and 456 (shown in FIGS. 5a and 5b respectively) to reflect the appropriate time intervals.

Remote Control Unit 104

In a specific example, the remote control unit 104 has an interface allowing an operator 110 to enter commands. Typically, the interface includes a control panel with switches and levers allowing the operator 110 to remotely control the movement of the locomotive. The remote control unit includes an interface for transmitting signals over a first communication link (F1). In a non-limiting implementation, the control unit also includes an interface for receiving signals over a second communication link (F2).

The remote control unit 104 includes a transmitter portion. The transmitter portion is for generating command signals directed to the trail controller 106 onboard the locomotive and is adapted to transmit these commands over first communication channel (F1). In a specific implementation, the remote control unit 104 includes a receiver portion. The receiver portion is for receiving trail controller signals originating from either one of the trail controller 106 and the repeater 102 over second communication channel (F2).

A specific non-limiting implementation of the transmitter portion of remote control unit 104 is shown in FIG. 4a. The remote control unit 104 comprises a set of functional modules namely a user interface 301, a message builder unit 300, a message encoder 302 and a signal transmitting unit 318. The signal transmitting unit 318 includes an input for receiving the signal to be transmitted. The signal is supplied to a modulator 304 that modulates the signal and transfers it to a signal transmitter 306 that effects the actual transmission. The modulator 304 is coupled to a modulating frequency generator 312. The signal transmitter 306 is coupled to a time interval control module 322. The time interval control module 322 stores data for controlling the time interval for the transmission of the signal.

In a typical interaction, the user of the remote control system 100 enters via the user interface 301 a command to be executed by the locomotive. The user interface 301 may be a keyboard, touch screen, speech recognition system or any other suitable input means. In a preferred embodiment, the user interface 301 comprises a set of buttons or levers for each of the allowable actions namely braking, accelerating, reversing and so on. Once the command has been entered the message builder unit 300 processes it. The message builder unit 300 assembles the received command with addressing information stored in computer readable storage media 308 and the command codes stored in table 314. Such computer readable storage media are in the form of a read-only memory (ROM), programmable read-only memory (PROM) modules, EPROM or any other suitable register devices. The addressing information may be provided in any suitable form without detracting from the spirit of the invention. An example addressing is described in U.S. patent application Ser. No. 10/163,227 published Oct. 17, 2002 under publication number 20020152008 and in U.S. patent application Ser. Nos. 10/163,199 published Oct. 10, 2002 under publication number 20020146082. The content of these documents is hereby incorporated by reference. The command and the addressing information are digitally represented. Many message formats may be used here and the use of a particular message format does not detract from the spirit of the invention.

Optionally, once the message is created (the command including the addressing information), an encoding algorithm is applied by the message encoder 302 in order to reduce the occurrence of consecutive 0's or 1's in the message and therefore permit a self-synchronizing communication. Many encoding methods are known in the art of digital signal processing and the use of other encoding methods does not detract from the spirit of the invention.

Once the message has been created, the message is passed to the signal transmitting unit 318, in particular to the modulator 304 that modulates the digital signal containing the message at the carrier frequency (F1). The carrier frequency generator 312 outputs the carrier frequency. Following the modulation of the signal, a signal transmitter module 306 transmits the signal at predetermined time intervals. The time interval control module 322 controls the time interval during which the signal transmitting unit 318 is permitted to issue signal over the first communication link (F1).

The time interval control module 322 is adapted to receive over an interface (not shown) timing information in the form of a reference clock signal as well as timing information indicative of the time intervals during which the remote control unit 104 is permitted to transmit signals. The reference clock signal typically marks the boundaries of a TDMA frame. The time interval control module 322 may receive the reference clock signal over the second communication link (F2) or via an alternate communication link. In a specific implementation, the reference clock signal is derived on the basis of a GPS system and the time interval control module 322 interfaces with the GPS system. The time intervals during which the remote control unit 104 is permitted to transmit are stored on a computer readable medium in time interval control module 322. These time intervals may be provided through a manually operable interface on the remote control unit, over second communication link (F2), over an alternate communication link in communication with time interval control module 322. The alternate communication link may be another RF link, an IR link, a wireline interface (including an optical link) or any other suitable communication link.

In this fashion, the time interval control module 322 allows the remote control unit 104 to transmit signals during certain time intervals and prevents the transmission of signals during other time intervals.

A specific non-limiting implementation of the receiver portion of remote control unit 104 is shown in FIG. 4b. The remote control unit 104 comprises a set of functional modules namely a signal receiving unit 368, a message decoder 352 and a message authentication unit 350. The signal receiving unit 368 includes a signal receiver in the form of an RF antenna for receiving the signal transmitted. The signal is supplied to a demodulator 354 that demodulates the signal. The demodulator 354 is coupled to a demodulating frequency generator 362 adjusted to the frequency of the second communication channel (F2). The message decoder receives the demodulated signal and applies a decoding function. The decoding function applied by message decoder 352 is the inverse function applied by message encoder 302 (shown in FIG. 4a). The decoded message is then forwarded to the message authentication unit 350. The message authentication unit compares the addressing information stored in the decoded message with the addressing information stored in the addressing information unit 308. The message authentication unit may also implement other verification steps such as message integrity verification, amongst others. Once the message authentication unit 350 has authenticated the message, the message is processed in a known manner by the remote control unit.

The Repeater Unit 102

In a specific implementation, the repeater unit 102 is a ground-based unit whose function is to extend the radio frequency (RF) range of the remote control unit 104. In a specific example, the signal range is extended by amplifying the signal and filtering noise components. Repeater units are well-known in the art to which this invention pertains and typically comprise an RF receiver, a decoder/encoder, an RF re-transmitter and any other equipment such as filters, duplexors and others required to receive a signal, process it and retransmit it.

FIG. 4a is a functional block diagram of the repeater module 102 showing the components which are active in the first communication channel (F1). As shown, the repeater module 102 includes a receiver 400, a processing unit 402, a re-transmitter 404 and a time interval control unit 406. The receiver 400 is adapted for receiving a demodulated signal transmitted over the first communication channel (F1). The processing unit 402 is adapted for processing the signal received to generate an altered version of the signal. In a non-limiting implementation, the processing unit 402 filters noise contained in the signal and amplifies the signal. The re-transmitter 404 receives the altered version of the signal and retransmits it over the first communication channel (F1) at predetermined time intervals. The time interval control module 406 controls the time intervals during which the re-transmitter 404 is permitted to issue signals over the first communication link (F1).

The time interval control module 406 is adapted to receive over an interface (not shown) timing information in the form of a reference clock signal as well as timing information indicative of the time intervals during which the repeater unit 102 is permitted to transmit signals over the first communication channel (F1). The reference clock signal typically marks the boundaries of a TDMA frame. The time interval control module 406 may receive the reference clock signal over the second communication link (F2), via the first communication link (F1) or via an alternate communication link. In a specific implementation, the reference clock signal is derived on the basis of a GPS system and the time interval control module 406 interfaces with the GPS system. The time intervals during which the repeater module 102 is permitted to transmit are stored on a computer readable medium in time interval control module 406. These time intervals may be provided through a manually operable interface, over second communication link (F2), over an alternate communication link in communication with time interval control module 406. The alternate communication link may be another RF link, an IR link, a wireline interface (including an optical link) or any other suitable communication link. The time intervals provided by the time interval control module 406 are such that they are non-overlapping with the time intervals provided by the time interval control module 322 (shown in FIG. 4b).

FIG. 5b is a functional block diagram of the repeater module showing the components which are active in the second communication channel (F2). As shown, the repeater module 102 includes a receiver 450, a processing unit 452, a re-transmitter 454 and a time interval control unit 456. The receiver 450 is adapted for receiving a demodulating a signal transmitted over the second communication channel (F2). The processing unit 452 is adapted for processing the signal received to generate an altered version of the signal. In a non-limiting implementation, the processing unit 452 filters noise contained in the signal and amplifies the signal. The re-transmitter 454 receives the altered version of the signal and retransmits it over the second communication channel (F2) at predetermined time intervals. The time interval control module 456 controls the time intervals during which the re-transmitter 454 is permitted to issue signals over the second communication channel (F2). The time interval control module 456 may be implemented in the same fashion as interval control module 406 and as such will not be described further here. Optionally, the time interval control modules 456 and 406 are implemented as a same module such that the repeater module 104 can issue signals over the two communication channels during the same time interval.

Trail Controller 106

The trail controller 106 receives and demodulates the RF signal originating from the remote control unit 104 or from the repeater unit 102. The trail controller 106 then causes the commands included in the signal to be implemented at the locomotive. The implementation procedure consists of generating the proper control signals and interfacing those control signals with the main controller module 112 provided in the locomotive to regulate the operation of the engine, braking system and other devices. The controller module 112 communicates with the trail controller 106 via standard asynchronous serial communication links 124 or any other suitable communication links.

FIG. 5a is a functional block diagram of a trail controller showing components which are active in the first communication channel (F1). The trail controller 106 includes a receiver unit 502 that senses the signal transmitted over the first communication channel (F1). In addition, the trail controller 106 includes a logical processing unit 508 to process the received signal and to generate the necessary control signals that are input to the locomotive controller module 112 so the desired command can be implemented. The logical processing station 508 also performs the validation of a message received at the receiver 502.

FIG. 5b is a functional block diagram of a trail controller showing components which are active in the second communication channel (F2). The trail controller 106 includes a transmitter unit 552, a logical processing unit 558 and an interval control unit 522.

The logical processing unit 558 generates messages for transmission to the remote control unit 104. The content of the messages may vary from one application to another and may include, without being limited to, an acknowledgement of receipt of an instruction, status information for the locomotive, timing information and any other information that may be useful to improve the control of the locomotive from the remote control unit 104. Optionally, the logical processing unit 558 may also generate timing information, including the generation of a reference clock signal, for transmission to the remote control unit 104 and the repeater unit 102. In such an implementation, the logical processing unit 558 may assign the time intervals in a TDMA frame during which the repeater module 102 and the remote control 104 unit may transmit over the first communication channel (F1). The logical processing unit 558 may also assign the time intervals in a TDMA frame during which the repeater module 102 and the trail controller 106 may transmit over the second communication channel (F2).

It will be appreciated that the time intervals may be assigned by an entity distinct from the repeater module 102, the trail controller 106 and the remote control unit 104 without detracting from the spirit of the invention.

The transmitter unit 552 receives message from the logical processing unit 558 and transmits it over the second communication channel (F2) at predetermined time intervals. The time interval control module 522 controls the time intervals during which the transmitter unit 552 is permitted to issue signals over the second communication link (F2).

The time interval control module 522 is adapted to receive over an interface (not shown) timing information in the form of a reference clock signal as well as timing information indicative of the time intervals during which the trail controller 106 is permitted to transmit signals over the second communication channel (F2). The reference clock signal typically marks the boundaries of a TDMA frame. The time interval control module 522 may receive the reference clock signal over the second communication link (F2), via the first communication link (F1) or via an alternate communication link. In a specific implementation, the reference clock signal is derived on the basis of a GPS system and the time interval control module 522 interfaces with the GPS system. The time intervals during which the trail controller 106 is permitted to transmit are stored on a computer readable medium in time interval control module 522. These time intervals may be provided through a manually operable interface, over second communication link (F2), over an alternate communication link in communication with time interval control module 406. The alternate communication link may be another RF link, an IR link, a wireline interface (including an optical link) or any other suitable communication link. The time intervals provided by the time interval control module 522 are such that they are non-overlapping with the time intervals provided by the time interval control module 456 (shown in FIG. 5b).

Although the present invention has been described in considerable detail with reference to certain preferred embodiments thereof, variations and refinements are possible without departing from the spirit of the invention as have been described throughout the document.

Therefore, only the appended claims and their equivalents should limit the scope of the invention.

1) A system for remotely controlling a locomotive, said system comprising:
a) a remote control unit adapted for transmitting, during a first time interval, a remote control signal over a given communication channel;
b) a repeater module adapted for:
i) receiving the remote control signal transmitted over the given communication channel by the remote control unit;
ii) processing the remote control signal to generate an amplified version of the remote control signal;
iii) transmitting the amplified version of the remote control signal over the given communication channel during a second time interval, the first time interval and the second time interval being non-overlapping;
c) a trail controller positioned onboard the locomotive, said trail controller being adapted for receiving either one of the remote control signal and the amplified version of the remote control signal over the given communication channel.

2) A system as defined in claim 1, said given communication channel being a first communication channel, wherein:
a) said trail controller is adapted for transmitting, during a third time interval, a trail controller signal over a second communication channel distinct from the first communication channel;
b) said repeater module is adapted for:
i) receiving the trail controller signal transmitted over the second communication channel by the trail controller;
ii) processing the trail controller signal transmitted over the second communication channel by the trail controller to generate an amplified version of the trail controller signal;
iii) transmitting the amplified version of the trail controller signal over the second communication channel during a fourth time interval, the third time interval and the fourth time interval being non-overlapping;
c) said remote control unit being adapted for receiving either one of the trail controller signal and the amplified version of the trail controller signal over the second communication channel.

3) A system as defined in claim 2, wherein the first time interval is overlapping at least in part with either one of the third time interval and the fourth time interval.

4) A system as defined in claim 2, wherein the second time interval is overlapping at least in part with either one of the third time interval and the fourth time interval.

5) A system as defined in claim 1, wherein the given communication channel is a radio frequency channel.

6) A system as defined in claim 2, wherein the first communication channel and the second communication channel are radio frequency channels.

7) A system as defined in claim 1, comprising a plurality of remote control units adapted for transmitting remote control signals over the given communication channel, the remote control being assigned respective time sub-intervals of the first time interval, the time sub-intervals being non-overlapping with one another.

8) A system as defined in claim 1, comprising a plurality of repeater modules adapted for:
i) receiving remote control signals transmitted over the given communication channel;
ii) re-transmitting the remote control signals over the given communication channel, the repeaters being assigned respective time sub-intervals of the second time interval, the time sub-intervals of the second time interval being non-overlapping with one another.

9) A system for remotely controlling a locomotive, said system comprising:
a) a trail controller positioned onboard the locomotive, said trail controller being adapted for transmitting, during a first time interval, a trail controller signal over a given communication channel;
b) a repeater module adapted for:
i) receiving the trail controller signal transmitted over the given communication channel by the trail controller;
ii) processing the trail controller signal to generate an amplified version of the trail controller signal;
iii) transmitting the amplified version of the trail controller signal over the given communication channel during a second time interval, the first time interval and the second time interval being non-overlapping;
c) a remote control unit adapted for receiving either one of the trail controller signal and the amplified version of the trail controller signal over the given communication channel.

10) A system as defined in claim 9, wherein the given communication channel is a radio frequency channel.

11) A method for assigning time intervals to communication components in a locomotive remote control system, the time intervals indicating time segments during which a communication component is permitted to transmit a signal over a communication channel, said method comprising:
a) assigning a first time interval to a remote control unit for transmission of remote control signals over a first communication channel;
b) assigning a second time interval to a repeater module for transmission of remote control signals over the first communication channel, the first time interval and the second time interval being non-overlapping;
c) assigning a third time interval to a trail controller mounted onboard the locomotive for transmission of trail controller signals over a second communication channel distinct from the first communication channel;
d) assigning a fourth time interval to the repeater module for transmission of trail controller signals over the second communication channel, the third time interval and the fourth time interval being non-overlapping.

12) A system as defined in claim 11, wherein either one of the first time interval and the second time interval is overlapping at least in part with either one of the third time interval and the fourth time interval.

13) A system as defined in claim 11, wherein the first and second communication channels are distinct radio frequency channels.

14) A method as defined in claim 12, said method further comprising assigning respective time sub-intervals of said first time interval to a plurality of remote control units, each remote control unit being adapted for transmitting remote control signals over the first communication channel during its respective time sub-interval, the time sub-intervals being non-overlapping with one another.

15) A method as defined in claim 14, said method further comprising, assigning respective sub-intervals of said third time interval to a plurality of trail controllers mounted onboard respective locomotives, each trail controller being adapted for transmitting trail controller signals over the second communication channel during its respective time sub-interval, the time sub-intervals of the third time interval being non-overlapping with one another.

16) A method as defined in claim 12, said method further comprising assigning respective time sub-intervals of said second time interval to a plurality of repeater modules, each repeater module being adapted for transmitting remote control signals over the first communication channel during its respective time sub-interval, the time sub-intervals being non-overlapping with one another.

17) A method as defined in claim 11, wherein the first time interval is assigned manually.

18) A method as defined in claim 11, wherein the first, second, third and fourth time intervals are measured with respect to a reference clock.

19) A method as defined in claim 18, wherein the reference clock is derived in the basis of a GPS system.

20) A method for assigning time intervals to communication components in a locomotive remote control system, the time intervals indicating time segments during which a communication component is permitted to transmit a signal over a communication channel, said method comprising:
a) assigning a first time interval to a remote control unit for transmission of remote control signals over a first communication channel to a trail controller positioned onboard a locomotive;
b) assigning a second time interval to a repeater module for transmission of remote control signals over the first communication channel to the trail controller positioned onboard a locomotive, the first time interval and the second time interval being non-overlapping.
